(19) United States
(12) Patent Application Publication
(10) Pub. No.: US 2007/0282984 A1
(43) Pub. Date: Dec. 6, 2007

(54) AUTONOMIC WEB SERVICES PRICING MANAGEMENT

(76) Inventors: Ronald P. Doyle, Raleigh, NC (US); David L. Kaminsky, Chapel Hill, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/422,200

(22) Filed: Jun. 5, 2006

(51) Int. Cl. G06F 15/173

(52) U.S. Cl. 709/223

(57) ABSTRACT

Embodiments of the present invention address deficiencies of the art in respect to managing service level guarantees for a Web service and provide a method, system and computer program product for Web service pricing in an on-demand environment. In one embodiment of the invention, an automated Web services pricing management method can be provided. The method can include loading an economic model for a Web service, deploying the Web service and measuring quality metrics for the Web service. Once quality metrics have been measured for the Web service, the economic model can be consulted to identify a penalty for the Web service commensurate with the measured quality metrics. Thereafter, the penalty can be established for the Web service.

### BACKGROUND OF THE INVENTION

1. Field of the Invention

The present invention relates to the field of Web services and more particularly to the field of differentiated service processing in an on-demand environment.

2. Description of the Related Art

Web services represent the leading edge of distributed computing and are viewed as the foundation for developing a truly universal model for supporting the rapid development of component-based applications over the World Wide Web. Web services are known in the art to include a stack of emerging standards that describe a service-oriented, component-based application architecture. Specifically, Web services are loosely coupled, reusable software components that semantically encapsulate discrete functionality and are distributed and programmatically accessible over standard Internet protocols.

Conceptually, Web services represent a model in which discrete tasks within processes are distributed widely throughout a value net. Notably, many industry experts consider the service-oriented Web services initiative to be the next evolutionary phase of the Internet. Typically, Web services can be defined by an interface such as the Web services definition language (WSDL), and can be implemented according to the interface, though the implementation details matter little so long as the implementation conforms to the Web services interface. Once a Web service has been implemented according to a corresponding interface, the implementation can be registered with a Web services registry, such as Universal Description, Discover and Integration (UDDI), as is well known in the art. Upon registration, the Web service can be accessed by a service requester through the use of any supporting messaging protocol, including for example, the simple object access protocol (SOAP).

The vast majority of Web services process service requests indiscriminately. That is, regardless of the identity of the requestor or the type of request, each service request can be processed with equal priority. Given the exponential increase in network traffic across the Internet and the contemporary widespread deployment of Web services, however, more recently deployed Web services have begun to provide varying levels of responsiveness based upon what has been referred to as a “policy based service differentiation model”.

In a policy based service differentiation model, computing services, including Web services, can offer many levels of service where different requests for different services which originate from different requesters receive different levels of treatment depending upon administratively defined policies. In that regard, a service level agreement (SLA) can specify a guaranteed level of responsiveness associated with particular content or services irrespective of any particular requester. The recent “WS-Agreement” standards proposal elevates differentiated services for Web services well beyond the basic SLA.

WS-Agreement as proposed enables negotiation among a Web service consumer and a Web services provider and provides for pricing and penalty clauses traditionally associated with service level obligations. Generally, the penalty clauses require the payment of a penalty in the circumstance where a Web service fails to provide a requisite level of responsiveness. In an on-demand environment, however, the lessening of the performance guarantee for a Web service can have an unintended adverse consequence on the marketability of the Web service. Specifically, in a traditional response to an increasing load on a Web service, the service guarantee for accessing the Web service can be decreased to accommodate the likelihood of failing to meet a previously promised level of responsiveness. To do so, however, detracts from the marketability of the Web service causing a decrease in revenue generated by the Web service.

### BRIEF SUMMARY OF THE INVENTION

Embodiments of the present invention address deficiencies of the art in respect to managing service level guarantees for a Web service and provide a novel and non-obvious method, system and computer program product for Web service pricing in an on-demand environment. In one embodiment of the invention, an automated Web services pricing management method can be provided. The method can include loading an economic model for a Web service, deploying the Web service and measuring quality metrics for the Web service. Once the quality metrics have been measured for the Web service, the economic model can be consulted to identify a penalty for the Web service commensurate with the measured quality metrics. Thereafter, the penalty can be established for the Web service.

Importantly, the method further can include additionally loading breach metrics for the Web service. As such an acceptable penalty for breaching a service level guarantee for the Web service can be selected based upon a probability of a breach occurring indicated by the breach metrics and the measured load. Thereafter, the acceptable penalty can be established for the Web service. Finally, in another aspect of the embodiment, consulting the economic model to identify a price for the Web service commensurate with the measured load can include locating a range of acceptable penalties for the measured load for the Web service, wherein each acceptable penalty corresponds to a different demand for the Web service. Consequently, a specific acceptable penalty can be identified that corresponds to a maximum demand for the Web service.

Another embodiment of the invention can include an automated Web service pricing data processing system. The system can include a workload manager configured for coupling to multiple different Web services and corresponding multiple different economic models. The system also can include a data store of prices and penalties for different service level guarantees for different ones of the Web services. Finally, the system can include automated pricing logic. The automated pricing logic can include program code enabled to consult the economic models to set either or both of prices and penalties for the Web services commensurate with measured loads on each of the Web services, breach metrics for each of the Web services, and a desired demand for each of the Web services.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an on-demand data processing configured for automated Web service pricing; and,

FIG. 2 is a flow chart illustrating a process for automated Web service pricing in an on-demand environment.

### DETAILED DESCRIPTION OF THE INVENTION

Embodiments of the present invention provide a method, system and computer program product for automated Web service pricing in an on-demand environment. In accordance with an embodiment of the present invention, an economic model for consumer demand response for a Web service can be established for varying Web service pricing, service guarantees and penalties for the Web service. Additionally, the probability of a breach of a set of guarantees can be computed for varying loads. Subsequently, the load on the Web service can be measured and the service guarantee and penalty can be varied to achieve a target demand for the Web service according to the economic model and the probability of a breach for the measured load.

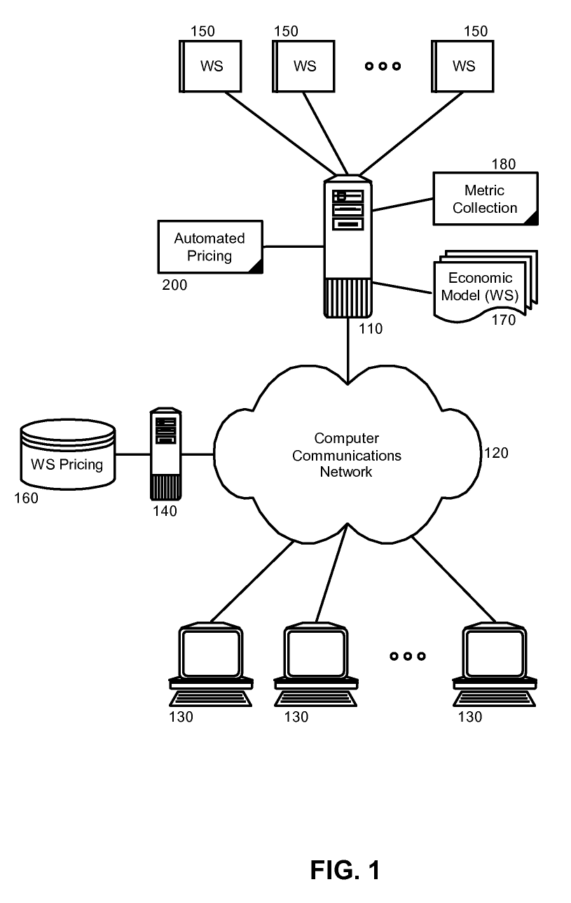

In further illustration, FIG. 1 is a schematic illustration of an on-demand data processing configured for automated Web service pricing. As shown in FIG. 1, the data processing system can include a workload scheduler 110 communicatively coupled to one or more computing consumers 130 over a computer communications network 120. The workload scheduler 110 can be configured to process requests for logic processing or content from managed Web services 150. In this regard, the workload scheduler 110 can determine the load in different requested ones of the Web services 150 and can route the requests accordingly in order to satisfy the requests in as expeditious manner as possible

Each of the Web services 150 can include a published price and service level guarantee in a data store of Web services pricing 160 associated Web services directory 140. The data store of Web services pricing 160 further can store a specified penalty for individually stored guarantees, the penalty providing for the contingency when the guarantee becomes breached due to the load experienced by a corresponding one of the Web services 150. Finally, the Web services directory 140 can be configured to provide the pricing, guarantee and penalty data for a particular one of the Web services 150 responsive to a request by one of the computing consumers 130.

According to FIG. 1, the workload scheduler 110 can be coupled to metric collection logic 180. The metric collection logic 180 can include program code enabled to collect breach metrics for the Web services 150 such as a load experienced for the individual ones of the Web services 150 and whether or not a breach of a service level guarantee resulted from a given load. In consequence, the breach metrics collected through the program code of the metric collection logic 180 can provide probability of a breach of a service level guarantee for a particular load of a particular Web service.

Yet further according to FIG. 1, one or more economic models 170 can be provided for one or more of the Web services 150. Each of the economic models 170 can tabulate a demand for a corresponding one of the Web services for a particular price, guarantee, penalty, or any combination thereof Each of the economic models 170 can be generated through the program code of the metric collection logic 180, or the economic models 170 can be generated statically through manual intervention. In any event, automated pricing logic 200 can include program code enabled to utilize the economic models 170 in establishing a price, guarantee and penalty for a corresponding one of the Web services 150 based upon the breach metrics for the corresponding one of the Web services 150.

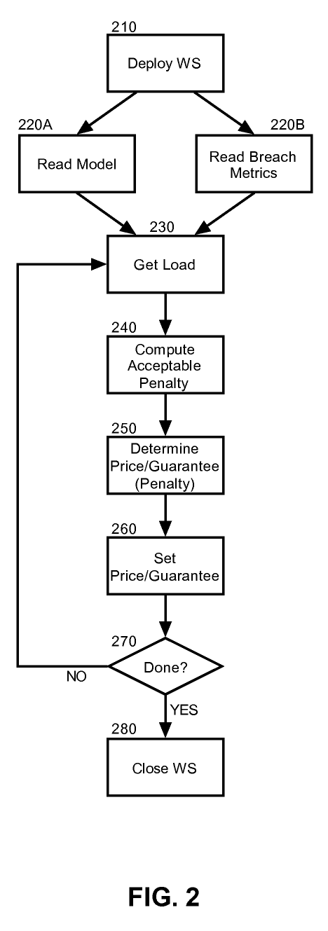

In more particular illustration, FIG. 2 is a flow chart illustrating a process for automated Web service pricing in an on-demand environment. Beginning in block 210, a Web service can be deployed into the on-demand environment and published for use in an associated directory accessible by one or more service consumers. In block 220A, an economic model for the Web service can be loaded. Likewise, in block 220B, breach metrics can be loaded for the Web service. Thereafter, service consumers can access the Web service through a series of requests thereby imposing a load on the Web service and in block 230, the load can be measured for the Web service.

In block 240, an acceptable penalty can be established for the Web service. The acceptable penalty can consider the likelihood of a breach for the measured load according to the breach metrics collected for the Web service. In block 260, the acceptable penalty can be used to determine a set of price and service level guarantees associated with the acceptable penalty for a demand range for the Web service as outlined in the economic model for the Web service. As such, a price and service level guarantee can be selected in order to achieve a desired demand while balancing the acceptable penalty for the load experienced by the Web service. Specifically, in response to varying load, preferably the penalty is adjusted while the guarantee is kept approximately constant. In decision block 270, if the Web service is to accept further requests, the process can repeat through block 230. Otherwise the process can end in block 280.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An automated Web services pricing management method comprising:
loading an economic model for a Web service;
deploying the Web service;
measuring a quality metric for the Web service;
consulting the economic model to identify a penalty for the Web service commensurate with the measured quality metrics; and,
setting the penalty for the Web service.

2. The method of claim 1, further comprising:
further loading breach metrics for the Web service;
selecting an acceptable penalty for breaching a service level guarantee for the Web service based upon a probability of a breach occurring indicated by the breach metrics and the measured load; and,
setting the acceptable penalty for the Web service.

3. The method of claim 2, further comprising recording a demand for the Web service for different prices and penalties to produce the economic model.

4. The method of claim 2, further comprising identifying breach occurrences for different loads experienced by the Web service to produce the breach metrics.

5. The method of claim 2, wherein consulting the economic model to identify a penalty for the Web service commensurate with the measured quality metrics, comprises:
locating a range of acceptable penalties for the measured load for the Web service, each acceptable penalty corresponding to a different demand for the Web service; and,
identifying a specific acceptable penalty corresponding to a maximum demand for the Web service.

6. In an on-demand environment, an automated Web service pricing data processing system comprising:
a workload manager configured for coupling to a plurality of Web services and a plurality of economic models, each corresponding to one of the Web services;
a data store of prices and penalties for different service level guarantees for different ones of the Web services; and,
automated pricing logic comprising program code enabled to consult the economic models to set at least one of prices and penalties for the Web services commensurate with measured loads on each of the Web services, breach metrics for each of the Web services, and a desired demand for each of the Web services.

7. The system of claim 6, wherein the data store of prices and penalties is coupled to a Web services directory.

8. The system of claim 6, further comprising metric collection logic coupled to the workload manager, the metric collection logic comprising program code enabled to collect the breach metrics for the Web services.

9. A computer program product comprising a computer usable medium embodying computer usable program code for automated Web services pricing management, the computer program product including:
computer usable program code for loading an economic model for a Web service;
computer usable program code for deploying the Web service;
computer usable program code for measuring quality metrics for the Web service;
computer usable program code for consulting the economic model to identify a penalty for the Web service commensurate with the measured quality metrics; and,
computer usable program code for setting the penalty for the Web service.

10. The computer program product of claim 9, further comprising:
computer usable program code for further loading breach metrics for the Web service;
computer usable program code for selecting an acceptable penalty for breaching a service level guarantee for the Web service based upon a probability of a breach occurring indicated by the breach metrics and the measured load; and,
computer usable program code for setting the acceptable penalty for the Web service.

11. The computer program product of claim 10, further comprising computer usable program code for recording a demand for the Web service for different prices and penalties to produce the economic model.

12. The computer program product of claim 10, further comprising computer usable program code for identifying breach occurrences for different loads experienced by the Web service to produce the breach metrics.

13. The computer program product of claim 10, wherein the computer usable program code for consulting the economic model to identify a penalty for the Web service commensurate with the measured quality metrics, comprises:
computer usable program code for locating a range of acceptable penalties for the measured load for the Web service, each acceptable penalty corresponding to a different demand for the Web service; and,
computer usable program code for identifying a specific acceptable penalty corresponding to a maximum demand for the Web service.
